(19) United States
(12) Patent Application Publication
(10) Pub. No.: US 2014/0278490 A1
(43) Pub. Date: Sep. 18, 2014

(54) System and Method For Grouping Medical Codes For Clinical Predictive Analytics

(71) Applicant: OPERA SOLUTIONS, LLC, Jersey City, NJ (US)

(72) Inventors: Mahdi Namazifar, San Diego, CA (US); Wen Zhang, San Diego, CA (US); Yan Zhang, San Diego, CA (US)

(73) Assignee: OPERA SOLUTIONS, LLC, Jersey City, NJ (US)

(21) Appl. No.: 14/200,725

(22) Filed: Mar. 7, 2014

Related U.S. Application Data
(60) Provisional application No. 61/777,246, filed on Mar. 12, 2013.

(51) Int. Cl. G06F 19/00

(52) U.S. Cl. CPC G06F 19/327
USPC 705/2

(57) ABSTRACT

A system and method for grouping medical codes for clinical predictive analytics is provided. The system for predictive modeling using medical information comprising a computer system for electronically receiving a data set of medical diagnosis codes and applying indicator variables to the data set, the computer system allowing a user to define a target and one or more thresholds conditions, a supervised variable grouping engine executed by the computer system, said engine calculating, for each indicator variable, a vector length and a distance to a target vector, wherein each indicator variable initially forms a group, automatically combining two groups of indicator variables that satisfy threshold conditions to create a combined group, recalculating the combined group's vector length, distance to the target vector, and distance to vectors of other remaining groups, iteratively combining and recalculating until there are no two groups that satisfy the threshold conditions or until a satisfactory number of groups is formed; and generating an altered data set of medical code groupings with reduced dimensionality and inputting the altered data set into a predictive model.

### CROSS-REFERENCE TO RELATED APPLICATION

This application claims priority to U.S. Provisional Patent Application No. 61/777,246 filed on Mar. 12, 2013, which is incorporated herein by reference in its entirety.

### BACKGROUND

1. Field of the Disclosure

The present disclosure relates generally to systems for predictive modeling using medical information. More specifically, the present disclosure relates to a system and method for grouping medical codes for clinical predictive analytics.

2. Related Art

With more and more health care data becoming available digitally, predictive analytics tools have become increasingly important for healthcare providers and payers. For health care providers, predictive analytics, in combination with expert knowledge, can be used to reduce medical costs and improve care, such as by being used to assist in the diagnosis of numerous diseases, create personalized treatment plans, target patients with high risk of readmission for resource allocation, target potential patients with specific diseases, etc. Predictive analytics could help determine which patients need a more thorough follow-up appointment, and could help providers find errors in their claims (e.g., missing charges, upcodings, etc.). For payers, predictive analytics has been used for risk adjustment, primarily to determine health plan premiums and encounter capitation payments. Another main focus of predictive solutions is medical fraud prevention and detection, where over $60 billion is estimated for the Medicare program alone. Other applications include medical necessity, claim qualification, overcharge, and medical abuse detection.

More specifically, it is important for hospitals to cut down readmission rates because readmission to a hospital shortly after hospital discharge is undesirable to both the patient and the hospitals. Hospital readmissions can cause a significant decrease in the quality of life of the patient, and is often avoidable. There is a high cost associated with readmission for health care facilities and insurance companies. Further, new U.S. federal health laws financially penalize hospitals with higher than expected readmission rates. It would be desirable to have a model that could predict the probability of readmission right before hospital discharge, so that extra care could be applied to the patient to avoid the need for readmission.

One of the key problems in heath care data analysis relates to numerous codes that are utilized in health care related data sets. Electronic Medical Records (EMR) are computerized records relating to the medical history and care of patients. EMRs contain several coding systems to record non-numerical values, such as the ICD-9 standard which captures diagnoses and procedures. These codes need to be converted into numerical values to be used in predictive analytics. Due to the large number of different values of medical codes (e.g., ICD-9 standard has approximately 13,000 diagnosis codes), the codes need to be grouped (e.g., Diagnosis Related Groups (DRG)). The majority of the existing groupings of medical codes are based on domain knowledge, as opposed to being data driven. This means that these groupings would not necessarily be a good fit for a specific data set because they are not tailored for that data set, and do not consider the specific target variable of the problem, and consequently do not address the purpose of predictive analytics directly. In other words, the process of building these groupings is unsupervised. Accordingly, there is a need for better grouping of medical codes for predictive analytics purposes.

### SUMMARY

The present disclosure relates to a system and method for grouping medical codes for clinical predictive analytics. The system includes a computer system and an engine executed by the computer system. The system of the present disclosure generates data-driven groupings of codes (e.g., medical diagnoses codes) relative to the predicted target to be used in healthcare predictive analytics. The system executes a Supervised Variable Grouping (SVG) process which is a supervised and data-driven grouping process for medical codes for use in predictive analytics models. Using a dimensionality reduction approach, SVG groups medical codes with respect to their inter-relations and their relation to the target, resulting in dimensionality reduction.

### BRIEF DESCRIPTION OF THE DRAWINGS

The foregoing features of the disclosure will be apparent from the following Detailed Description, taken in connection with the accompanying drawings, in which:

FIG. 1 is a flowchart illustrating processing steps carried out by the system of the present disclosure;

FIGS. 2-4 are diagrams illustrating Supervised Variable Grouping (SVG) of the present disclosure;

FIGS. 5-6 are graphs illustrating computation results of applying SVG for prediction of hospital readmission; and

FIG. 7 is a diagram showing hardware and software components of the system.

### DETAILED DESCRIPTION

The present disclosure relates to a system and method for grouping medical codes for clinical predictive analytics, as discussed in detail below in connection with FIGS. 1-7.

FIG. 1 is a flowchart illustrating processing steps 10 of the system of the present disclosure. In step 12, the system electronically receives a data set. Then, in step 14, the data set is altered by applying indicator variables. For example, consider a data set with only one variable (e.g., a categorical variable) relating to medical codes (e.g., primary diagnosis). Computing with these values is challenging since these values are categorical and not numerical. To overcome this challenge, indicator variables are introduced for every possible value that the variable can take. These indicator variables replace the categorical variable, and they take 0 or 1 as their values. For each row of the data set the value 1 for an indicator variable specifies that, for that row, the value of the categorical variable is the code that corresponds to that indicator variable. If there are many codes associated with a categorical variable (e.g., primary diagnosis variable could have 13,000 codes or more), then the dimensionality of the data set involving indicator variables will be very large.

Dimensionality reduction lowers the number of variables that are considered during the machine learning process. Dimensionality reduction is crucial in machine learning because it helps avoid dealing with inconvenient properties of high-dimensional data sets, including dimensionality. The importance of dimensionality reduction is discussed in C. M. Bishop, “Pattern Recognition and Machine Learning,” Springer (2006), and T. Hastie, et al., “The elements of Statistical Learning: Data Mining, Inference, and Prediction,” First Edition, Springer (2001), the entire disclosures of which are incorporated herein by reference. A survey of dimensionality reduction techniques is presented in I. K. Fodor, “A survey of dimension reduction techniques,” Tech. rep., U.S. Department of Energy, Lawrence Livermore National Library (2002), the entire disclosure of which is incorporated herein by reference. Feature extraction, as opposed to feature selection, is a dimensionality reduction technique. In feature extraction, a high-dimensional data set is mapped onto a lower dimensional space through a transformation. During the transformation, the process tries to preserve as much predictive information as possible, while reducing the dimensionality.

In step 16, a Supervised Variable Grouping (SVG) process is executed by the system and applied to the data set, and more specifically to the indicator variables of the data set. SVG is a general dimensionality reduction technique and could be used for any type of numerical variables (indicator or non-indicator) for classification or regression problems. Applying SVG on variables of a dataset could significantly reduce the number of variables (e.g., indicator variables) resulting in a data set with a manageable number of dimensions for computation. SVG provides a grouping of indicator variables, which is equivalent to grouping the categories with respect to the target (where a grouping of categories could be tailored for each target so that two different groupings of the same set of categories based on two different targets could be significantly different). Such a grouping could be used as a basis for a smaller set of indicator variables that indicate whether or not a category falls into a specific group.

To apply SVG to the indicator variables, in step 17, the target is defined and thresholds for the length of the vectors and the distance of those vectors to the target is defined (e.g., by a user via a computer interface). The terms “column” and “vector” are used interchangeably because each column of a data set can be viewed as a vector. For example, for categorical variables (e.g., clinical diagnosis codes for primary diagnosis of patients, ICD-9 standard, etc.) with a large number of different categories, introducing indicator variables adds a large number of columns to the data set. Initially, each variable forms a group, and therefore initially the number of groups is the same as the number of variables of the data set, and the cardinality of each group is 1. The vector associated with each group is the sum of columns of the variables that are in the group. In step 18, the vector and distance to the target are calculated for each group.

In step 20, the system automatically searches for two groups that satisfy the threshold conditions (e.g., the maximum allowed threshold for the closeness of the length of two vectors and/or the threshold for the closeness of the length of either of the two vectors to the target). Recursively, at each iteration SVG finds two groups (e.g., pair of indicator variables) such that the length of the vectors associated with them are the closest, and the distance between those vectors and the target vector are the closest. In other words, the difference in their length and the difference in their distance to the target vector is less than the defined thresholds (e.g, ε₁ and ε₂). These variables are chosen in such a way that if linear regression were to be performed on the final output of SVG, the result would be similar to performing linear regression on the original data set with all of the original variables. In other words, the two variables are selected based on their individual features, as well as their interaction with the target variable.

If there are such groups, then in step 22, these two groups (e.g., variables) are combined (e.g., added) to form a combined group, and in step 24 the two individual groups are removed from the data set and replaced by the combined group (e.g., sum). In step 26, the length of the vector associated with the combined group is calculated. Then, in step 28, the distance to the target vector of the combined group is calculated. In step 30, the distances of the combined group to the vectors associated with the other remaining groups are calculated.

In step 32, the system determines whether a satisfactory number of groups has been created (i.e., the number of remaining variables is equal to a pre-specified number (k*)). If not, the process returns back to step 20. In this way, the process continues iteratively until the satisfactory number of groups has been created (e.g., the number of columns of the data set has reached a pre-specified level), or until there are no more pairs of variables satisfying the threshold conditions (e.g., there are no two columns that are approximately satisfying the conditions required for reducing the dimension of the data set any further).

If a determination is made in step 20 that there are not two groups that satisfy the threshold conditions, or if a determination is made in step 32 that there are a satisfactory number of groups, then the process proceeds to step 34, where the altered data set is used as input for one or more predictive models. In this way, SVG could be applied to indicator variables to build medical code groupings, which are then applied to a data set containing clinical claims records to effectively build data sets for medical prediction problems to be used in predictive models.

FIGS. 2-4 are diagrams illustrating the principle of SVG to iteratively combine and delete variables from a data set. Consider a data set D with a categorical variable, Vc, and assume a classification problem with the target vector T being a binary vector. Utilizing Euclidean Distance for both classification and regression problems, for each category of Vc a new indicator variable is added to D, where indicator variables are Vc₁, Vc₂, . . . , Vcₖ and k is the number of different categories of Vc. Note that the notation V_{c}_{ᵢ}^{j} indicates the jth element V_{c}_{ᵢ}. The binary values that these indicator variables take indicate whether or not that category is represented by the indicator variable. Assume the categorical variable is replaced by a set of indicator variables. For every jε{1, 2, . . . , m}, where m is the number of rows in the data set, there exists only one iε{1, 2, . . . , k} for which V_{c}_{ᵢ}^{j}=1 and for the rest of values of i, V_{c}_{ᵢ}^{j}=0. This is due to the fact that at each row of the data set D the categorical variable V_{c} takes only one categorical value. For any i and h in {1, 2, . . . , k} such that i≠h. then V_{c}_{ᵢ}ⁱV_{c}_{ₕ}=0. This means that all of the V_{c}_{ᵢ} columns for iε{1, 2, . . . , k} are orthogonal to each other, and are therefore linearly independent. This is because for any j, both V_{c}_{ᵢ}^{j} and V_{c}_{ₕ}^{j} cannot be equal to 1. Based on this orthogonality observation, the output of linear regression for T using V_{c}_{ᵢ}s is the sum of projections of T onto V_{c}_{ᵢ}s. If two of the indicator vectors are summed up together and the summation is replaced for the two vectors, the result is another indicator vector. This feature makes vector addition a good candidate for variable (e.g., category) grouping.

FIG. 2 illustrates the linear regression of T based on V₁ and V₂. Consider a data set D with m rows and three columns, V₁ and V₂, and the target column, T. V₁ and V₂ are the descriptive variables that are to be used to predict the values of the target variable T. V₁, V₂, and T can be considered as vectors in R^{m}. The result of training a linear regression on this data set is the projection of the target vector T on the plane on which V1 and V₂ reside (indicated by V₁⊕V₂).

FIG. 3 illustrates the linear regression of T when |V₁|₂=|V₂|₂ and |T−V₁|₂=|T−V₂|₂. The following shows that assuming vectors V₁ and V₂ have equal length, the vectors are also of equal Euclidean distance to the target vector T, and therefore the output/result of linear regression on V₁ and V₂ to predict the target vector T is the same as the output/result of linear regression on V₁+V₂ to predict T. Assuming that |V₁|₂=|V₂|₂ and |T−V₁|₂=|T−V₂|₂, linear regression for T using V₁ and V₂ is equivalent to linear regression for T using only V₁+V₂. More specifically, if |V₁|₂=|V₂|₂, |T−V₁|₂=|T−V₂|₂, and a₁ and a₂ are the linear regression coefficients for V₁ and V₂, respectively, then a₁=a₂. For proof consider that Proj_{V}_{₁}_{⊕V}_{₂}T=a₁V₁+a₂V₂ where a₁ satisfies V′₁(T−a₁V₁)=0 and a₂ satisfies V′₂(T−a₂V₂)=0. As a result V′₁T=a₁V′₁V₁ and V′₂T=a₂V′₂V₂, and since |V₁|₂=|V₂|₂, then a₁=a₂ because:

|T−V₁|₂=|T−V₂|₂ [symbol] |T|₂²−2V′₁T+|V₁|₂²=|T|₂²−2V′₂T+|V₂|₂² [symbol] V′₁T=V′₁T. Equation 1

The direct implication is that, given these assumptions, using V₁+V₂ for building a linear regression model for T produces the same result as using V₁ and V₂ separately. If all of the vectors and the target are linearly independent, the result of linear regression on the original data set is the same as the result of linear regression on the reduced data set. For linear regression the features of indicator vectors holds. For generalized linear models, due to the involvement of a linear combination of variables in one form or another, the intuition of SVG still holds. For general learning algorithms the gain of using SVG is less dimensions in the data set, and the intuition behind SVG for linear regression provide a basis for a reasonable transformation of the variables.

There are numerous distance measures that could be used for SVG besides Euclidean Distance, such as by using the risk of each category as the distance of its corresponding indicator column to the target vector (used only for classification problems), so that each category is replaced by its risk value. The risk value of a category is the ratio of the number of instances of the category with positive targets to the total number of instances of the category. Indicator variable risk measures the ratio of the number of positive targets when the indicator is 1 to the squared length of the indicator vector. As a result, in this approach the categorical values of Vc are replaced by numerical values, and the new column is Risk(Vc).

The Euclidean distance and risk are related in the case of indicator variables for binary targets. Both can be used as the measure of distance to the target. Consider the case where |V₁|=|V₂| and Risk(V₁)=Risk(V₂), V_{N}=V₁+V₂, and |V_{N}|=|V₁|+|V₂|=2|V₁|. Risk(V_{N}) could be calculated by:

$$\begin{matrix}Risk ( {V}_{N} ) = \frac{{V}_{N}^{′} T}{{\vert {V}_{N} \vert}_{2}^{2}} \\ = \frac{{( {V}_{1} + {V}_{2} )}^{′} T}{2 {\vert {V}_{1} \vert}_{2}^{2}} \\ = \frac{{V}_{1}^{′} T + {V}_{2}^{′} T}{2 {\vert {V}_{1} \vert}_{2}^{2}} \\ = \frac{{V}_{1}^{′} T}{2 {\vert {V}_{1} \vert}_{2}^{2}} + \frac{{V}_{2}^{′} T}{2 {\vert {V}_{1} \vert}_{2}^{2}} \\ = \frac{{V}_{1}^{′} T}{2 {\vert {V}_{1} \vert}_{2}^{2}} + \frac{{V}_{2}^{′} T}{2 {\vert {V}_{2} \vert}_{2}^{2}} \\ = \frac{Risk ( {V}_{1} )}{2} + \frac{Risk ( {V}_{2} )}{2} \\ = Risk ( {V}_{1} ) \\ = Risk ( {V}_{2} ) .\end{matrix} \qquad Equation 2$$

This indicates that if the risk is considered the distance measure between the vectors and the target in SVG, each new vector has the same risk as its parent vectors.

At each iteration, the SVG algorithm takes two vectors with equal length and equal distance to the target vector, sums them into one vector, and the result replaces the two vectors in the data set. Suppose that V₁ and V₂ are two vectors of D with the desired properties, namely |V₁|₂=|V₂|₂ and |T−V₁|₂=|T−V₂|₂. As a result:

$$\begin{matrix}{\vert T - {V}_{1} \vert}_{2} = {\vert T - {V}_{2} \vert}_{2} ⇔ {\vert T \vert}_{2}^{2} - 2 {V}_{1}^{′} T + {\vert {V}_{1} \vert}_{2}^{2} \\ = {\vert T \vert}_{2}^{2} - 2 {V}_{2}^{′} T + {\vert {V}_{2} \vert}_{2}^{2} ⇔ {V}_{1}^{′} T \\ = {V}_{1}^{′} T ⇔ \frac{ {V}_{1}^{′} T}{{\vert {V}_{1} \vert}_{2}^{2}} \\ = \frac{{V}_{1}^{′} T}{{\vert {V}_{2} \vert}_{2}^{2}} ⇔ Risk ( {V}_{1} ) \\ = Risk ( {V}_{2} ) .\end{matrix} \qquad Equation 3$$

where Risk(V₁) and Risk(V₂) are the risks of the categories corresponding to V₁ and V₂, respectively. Therefore, |V₁|₂=|V₂|₂ and |T−V₁|₂=|T−V₂|₂ for two categorical vectors V₁ and V₂ and the target vector T, meaning that V₁ and V₂ are of equal length and the Euclidean distance between V₁ and T is equal to the Euclidean distance between V₁ and T, and therefore Risk(V₁)=Risk(V₂). This means that the variables that are summed up together at each iteration of SVG have equal risk values. Reversely, if |V₁|₂=|V₂|₂ and Risk(V₁)=Risk(V₂), then |T−V₁|₂=|T−V₂|₂.

Assuming V_{N}=V₁+V₂, then |V_{N}|₂²=|V₁|₂²+|V₂|₂²=2|V₁|₂², such that V_{N}, V₁, and V₂ are indicator variables and only have 0 or 1 elements. Also, the squared 2-norm of a binary vector is the number of 1s in the vector, so that the number of 1s in V_{N} is equal to the sum of the number of 1s in V₁ and V₂. The distance of V_{N} (the new vector) to the target can be calculated (such as by the Pythagorean theorem) as follows:

$$\begin{matrix}{\vert T - {V}_{N} \vert}_{2}^{2} = {\vert {V}_{N} \vert}_{2}^{2} - 2 {V}_{N}^{′} T + {\vert T \vert}_{2}^{2} \\ = {\vert {V}_{1} \vert}_{2}^{2} + {\vert {V}_{2} \vert}_{2}^{2} - 2 {( {V}_{1} + {V}_{2} )}^{′} T + {\vert T \vert}_{2}^{2} \\ = {\vert {V}_{1} \vert}_{2}^{2} + {\vert {V}_{2} \vert}_{2}^{2} - 2 {V}_{1}^{′} T - 2 {V}_{2}^{′} T + {\vert T \vert}_{2}^{2} \\ = {\vert T - {V}_{1} \vert}_{2}^{2} + {\vert T - {V}_{2} \vert}_{2}^{2} - {T}^{2} .\end{matrix} \qquad Equation 4$$

SVG using risk performs differently than SVG using Euclidean distance. Using risk as the distance measure, the distance of the sum of two vectors to the target is the same as the distance of the two vectors to the target. Comparatively, using the Euclidean distance between the sum of two vectors to the target vector, the sum of the two vectors has a distance to the target which is different than the individual distance of the two vectors to the target vector. This affects the entire algorithm, since the vectors are added together in a recursive manner. Therefore, these two measures would provide different dimensionality reduction transformations of the indicator variables. Another distinction is that using risk for dimensionality reduction is only applicable for binary targets, whereas the Euclidean distance could be use for both binary and continuous targets. This makes the Euclidean distance measure a viable candidate for both classification and regression problems.

FIG. 4 illustrates the projection of target vector T onto Vᵢ. Assume a linear regression model is to be trained based only upon the indicator variables of a categorical variable (an assumption made to simplify the presentation of concepts and is not restrictive). The columns that are used for this linear regression are orthogonal, and therefore, the linear regression coefficient, aᵢ, for column Vᵢ, can be found by projecting the target vector onto each of the indicator columns, such that:

$${a}_{i} = \frac{{\vert {Proj}_{{V}_{i}} T \vert}_{2}}{{\vert {V}_{i} \vert}_{2}} \qquad Equation 5$$

In the case of using risk as the distance measure, SVG at each iteration finds two columns Vᵢ and Vⱼ such that |Vᵢ|=|Vⱼ| and Risk(Vᵢ)=Risk(Vⱼ), and then replaces Vᵢ and Vⱼ with a new vector which is equal to Vᵢ+Vⱼ, so that:

$$\begin{matrix}Equations 6 and 7 & \\ Risk ( {V}_{i} ) = \frac{{V}_{i}^{′} T}{{\vert {V}_{i} \vert}_{2}^{2}} & ( 6 ) \\ {Proj}_{{V}_{i}} T = \frac{{V}_{i}^{′} T}{{\vert {V}_{i} \vert}_{2}} \frac{{V}_{i}}{{\vert {V}_{i} \vert}_{2}} & ( 7 )\end{matrix}$$

which means that Proj_{V}_{ᵢ}T=Risk(Vᵢ)Vᵢ. Therefore, at each iteration, SVG picks Vᵢ and Vⱼ in a way that they take equal coefficients in the linear regression. In other words, if a_{V}_{ᵢ} and a_{V}_{ⱼ} are the linear regression coefficients of Vᵢ and Vⱼ, |Vᵢ|=|Vⱼ|, and Risk(Vᵢ)=Risk(Vⱼ), then a_{V}_{ᵢ}=a_{V}_{ⱼ} and the linear regression equation:

$$T = {a}_{0} + {a}_{1} {V}_{1} + {a}_{2} {V}_{2} + … + {a}_{i - 1} {V}_{i - 1} + {a}_{i} {V}_{i} + {a}_{i + 1} {V}_{i + 1} + … + {a}_{j - 1} {V}_{j - 1} + {a}_{j} {V}_{j} + {a}_{j + 1} {V}_{j + 1} + … + {a}_{k} {V}_{k } , \qquad Equation 8$$

can be rewritten as:

$$T = {a}_{0} + {a}_{1} {V}_{1} + {a}_{2} {V}_{2} + … + {a}_{i - 1} {V}_{i - 1} + {a}_{i + 1} {V}_{i + 1} + … + {a}_{j - 1} {V}_{j - 1} + {a}_{j + 1} {V}_{j + 1} + … + {a}_{k} {V}_{k} + {a}_{i} ( {V}_{i} + {V}_{j} ) \qquad Equation 9$$

Where the Euclidean distance measure is used for SVG, the above analysis would be the same because Risk(V₁)=Risk(V₂) [symbol] |T−V₁|₂=|T−V₂|₂. Therefore, all the above analysis holds for the case where in SVG, at each iteration, Vᵢ and Vⱼ are picked such that |Vᵢ|₂=|Vⱼ|₂ and |T−V₁|₂=|T−V₂|₂, which supports the use of Euclidean distance to measure the distance between each vector and the target vector.

FIGS. 5-6 and Table 1 illustrate processing results achieved by the system, for purposes of predicting hospital readmission. Utilizing the system of the present disclosure, predicting the probability of hospital readmission for patients about to be discharged from the hospital was considered for a specific application of medical code groupings. Many categorical variables were involved, including all the diagnosis codes of the patient and all the procedure codes of the hospitalization claims. These codes needed to be transformed into variables that could be used for computation and prediction. Each of the categorical variables could take a very large number of different values and, therefore, working with indicator variables without reducing dimensionality was impractical. Using the system of the present disclosure, the dimensionality of each set of indicator variables was reduced so that the output data set had a manageable number of variables. The outcome of performing SVG on these categorical variables was a grouping of the categories (e.g., performing SVG on primary diagnosis codes results in a grouping of the primary diagnosis codes).

To predict hospital readmission, assume a data set with its records representing hospitalization claim records, and its columns representing information regarding each claim. Each claim corresponds to a hospital stay, and the columns present information regarding each claim (e.g., length of stay, attending physician, claim diagnosis codes, claim procedures, etc.). More specifically, the values of the diagnosis code columns are ICD-9 codes, which are categorical values by nature because each of the 13,000 different ICD-9 code represents a condition. Among all of the features there were 10 columns representing the diagnosis codes associated with each claim (although not all of the 10 columns were necessarily populated for every claim), where such columns could be named ICD9 DGNS CD1 (e.g., representing the code for the primary diagnosis of the claim), ICD9 DGNS CD2 (e.g., representing the secondary diagnosis of the claim), . . . ICD9 DGNS CD10. Consider the first 5 of these 10 diagnosis columns and the target, which is 1 if the claim is followed by a readmission, and is 0 otherwise. Diagnosis related codes are (preferably) exclusively used because diagnosis related information is common to different clinical data sets. Comparatively, clinical data could come from a variety of sources, which could contain different information regarding the claims based on their origination. For instance, one data set might contain detailed information regarding charges associated with each hospitalization whereas another data set might have detailed information about the lab tests and medications associated with the hospitalizations. However, no matter where the data originated or the kind of information reflected therein, most clinical data sets have diagnosis related information.

An advantage of using SVG is that it takes the target into consideration when building the groups of diagnosis codes. An alternative to SVG is to group the 5 diagnosis codes according to domain knowledge, however, such groupings are undesirable because these groupings are for a general purpose and do not consider the specific target of the problem. Another alternative to grouping the 5 diagnosis codes is to use risk tables. One-dimensional risk tables are easy to compute and use, but they do not consider the co-occurrence of codes. For instance if a patient has both condition a and b they might be more prone to readmission compared to a patient who has one condition but not the other. Risk tables of a higher order could be used, but such use would be difficult due to the noise in the data that comes from the scarcity of combinations of codes. Moreover, in such data sets risk tables do not provide a viable solution if the history of the codes must be considered.

To assess the performance of SVG, the SVG grouping was compared to an existing benchmark grouping of ICD-9 codes grouped based on mortality rates and the relative similarity of diseases, and which was presented in Escobar, G., Green, et al., “Risk-adjusting Hospital Inpatient Mortality Using Automated Inpatient, outpatient, and Laboratory Databases,” Medical Care 46(3), 232-239 (2008), the entire disclosure of which is incorporated herein by reference. The benchmark grouping had 45 groups (e.g., acute myocardial infraction, chronic renal failure, gynecologic cancers, liver disorders, etc.). Another benchmark used was a data set which replaces the ICD-9 codes with their individual risk for each of the 5 diagnosis columns.

The data set had about 1,000,000 claims (records) and there are about 4500 to 5000 different ICD-9 codes under each of the five diagnosis columns (e.g., ICD9 DGNS CD1). Indicator variables were then created for all of the codes that appear in these columns. As a result the new data set had about 1,000,000 rows (the same number of rows as the original data set), and about 50,000 columns and one target column, which is the same as the target column in the original data set. The length of each column was calculated, as well as each column's distance to the target column.

The rows of each of these three data sets (e.g., data set using the risk table, data set using the benchmark grouping, and data set using the indicator variables) were split randomly (with the same random seed) into a training set (e.g., 60% of the rows) and a validation set (e.g., 40% of the rows). SVG could be implemented in the Python programming language and used to create 45 variables for each of the columns, which basically forms groups of ICD-9 codes for each column. The Euclidean distance measure and the risk table were used to measure the distance of each vector to the target. The groups were then built using the training set. While SVG was being applied for each diagnosis column, codes that appeared less than 10 times in that column for the entire training set were put in a separate group to remove noise introduced by the codes (which occur rarely in each column).

FIG. 5 illustrates how the values of the Euclidean distance to target are distributed for different lengths of the indicator columns associated with ICD9 DGNS CD1. The horizontal axis represents the value of the length of the vector and the vertical axis represents the distance to the target vector for each vector. Each point represents a vector (e.g., ICD-9 code). For a visual comparison, FIG. 6 illustrates the distribution if the risk of the codes in ICD9 DGNS CD1 column were used instead of the Euclidean distance to the target column. The horizontal axis represents the value of the length of the vector and the vertical axis represents the risk of the ICD-9 code corresponding to each vector. Each point represents a vector (e.g., ICD-9 code).

Four data sets were created based on the primary conditions variables (e.g., data set based on separate risk values of the diagnosis columns, data set based on ICD-9 benchmark grouping, data set built on SVG with the Euclidean distance measure, and data set based on SVG with risk as the distance measure). For each of these four data sets a logistic regression was trained on the training set, and the outcome was used to score the corresponding validation set. Logistic regression is merely an example of how these models could be built. SVG of the present disclosure could be applied to any healthcare predictive analytics with a target function. The area under the ROC curve (AUC) was calculated and the results are shown below:

TABLE 1

| | Separate | | SVG | | SVG | | | |
|---|---|---|---|---|---|---|---|---|
| | Risk | | Euclid | | Risk | | Benchmark | |
| | Test | Train | Test | Train | Test | Train | Test | Train |
| DGNS_CD1-DGNS_CD5 | 0.647 | 0.650 | 0.650 | 0.665 | 0.648 | 0.668 | 0.630 | 0.629 |
| DGNS_CD1-DGNS_CD4 | 0.645 | 0.648 | 0.648 | 0.661 | 0.646 | 0.664 | 0.626 | 0.624 |
| DGNS_CD1-DGNS_CD3 | 0.642 | 0.644 | 0.644 | 0.656 | 0.643 | 0.658 | 0.620 | 0.618 |
| DGNS_CD1-DGNS_CD2 | 0.635 | 0.637 | 0.636 | 0.646 | 0.636 | 0.648 | 0.610 | 0.608 |
| DGNS_CD1 | 0.611 | 0.614 | 0.611 | 0.618 | 0.611 | 0.619 | 0.589 | 0.582 |

Each row represents the results for their respective ranges of diagnosis codes. As shown, SVG, with both risk and the Euclidean distance measure, created data sets on which logistic regression performs significantly better compared to the data set created based on the benchmark diagnosis grouping (based on domain knowledge) and compared to the data set based on risk tables (which could indicate that SVG, but not the one dimensional risk tables, can capture part of the correlation between the different diagnosis columns).

FIG. 7 is a diagram showing hardware and software components of a computer system 100 the system of the present disclosure could be implemented. The system 100 comprises a processing server 102 which could include a storage device 104, a network interface 108, a communications bus 110, a central processing unit (CPU) (microprocessor) 112, a random access memory (RAM) 114, and one or more input devices 116, such as a keyboard, mouse, etc. The server 102 could also include a display (e.g., liquid crystal display (LCD), cathode ray tube (CRT), etc.). The storage device 104 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The server 102 could be a networked computer system, a personal computer, a smart phone, tablet computer etc. It is noted that the server 102 need not be a networked server, and indeed, could be a stand-alone computer system.

The functionality provided by the present disclosure could be provided by an SVG program/engine 106, which could be embodied as computer-readable program code stored on the storage device 104 and executed by the CPU 112 using any suitable, high or low level computing language, such as Python, Java, C, C++, C#, .NET, MATLAB, etc. The network interface 108 could include an Ethernet network interface device, a wireless network interface device, or any other suitable device which permits the server 102 to communicate via the network. The CPU 112 could include any suitable single- or multiple-core microprocessor of any suitable architecture that is capable of implementing and running the secure document distribution program 106 (e.g., Intel processor). The random access memory 114 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected is set forth in the following claims.

What is claimed is:

1. A system for predictive modeling using medical information comprising:
a computer system for electronically receiving a data set of medical diagnosis codes and applying indicator variables to the data set, the computer system allowing a user to define a target and one or more thresholds conditions;
a supervised variable grouping engine executed by the computer system, said engine:
calculating, for each indicator variable, a vector length and a distance to a target vector, wherein each indicator variable initially forms a group;
automatically combining two groups of indicator variables that satisfy threshold conditions to create a combined group;
recalculating the combined group's vector length, distance to the target vector, and distance to vectors of other remaining groups;
iteratively combining and recalculating until there are no two groups that satisfy the threshold conditions or until a satisfactory number of groups is formed; and
generating an altered data set of medical code groupings with reduced dimensionality and inputting the altered data set into a predictive model.

2. The system of claim 1, wherein when two individual groups of indicator variables are combined, the individual groups are removed from the data set.

3. The system of claim 1, wherein the threshold conditions defined by the user include thresholds for vector lengths, thresholds for distance of vectors to the target vector, and a threshold satisfactory number of groups.

4. The system of claim 1, wherein the supervised variable grouping engine uses Euclidean distance or risk as a measure of distance from the indicator variable vectors to the target.

5. The system of claim 1, wherein the data set contains records representing hospitalization claim records, and columns representing information regarding each claim.

6. The system of claim 1, wherein the medical diagnosis codes are ICD-9 codes.

7. A method for predictive modeling using medical information comprising:
electronically receiving at a computer system a data set of medical diagnosis codes;
applying indicator variables to the data set;
defining at the computer system a target and one or more threshold conditions;
calculating by a supervised variable grouping engine executed by the computer system, for each indicator variable, a vector length and a distance to a target vector, wherein each indicator variable initially forms a group;
automatically combining two groups of indicator variables that satisfy threshold conditions to create a combined group;
recalculating the combined group's vector length, distance to the target vector, and distance to vectors of other remaining groups;
iteratively combining and recalculating until there are no two groups that satisfy the threshold conditions or until a satisfactory number of groups is formed;
generating an altered data set of medical code groupings with reduced dimensionality; and
inputting the altered data set into a predictive model.

8. The method of claim 7, wherein when two individual groups of indicator variables are combined, the individual groups are removed from the data set.

9. The method of claim 7, wherein the threshold conditions defined by the user include thresholds for vector lengths, thresholds for distance of vectors to the target vector, and a threshold satisfactory number of groups.

10. The method of claim 7, wherein the supervised variable grouping engine uses Euclidean distance or risk as a measure of distance from the indicator variable vectors to the target.

11. The method of claim 7, wherein the data set contains records representing hospitalization claim records, and columns representing information regarding each claim.

12. The method of claim 7, wherein the medical diagnosis codes are ICD-9 codes.

13. A non-transitory computer-readable medium having computer-readable instructions stored thereon which, when executed by a computer system, cause the computer system to perform the steps of:
electronically receiving at a computer system a data set of medical diagnosis codes;
applying indicator variables to the data set;
defining at the computer system a target and one or more threshold conditions;
calculating by a supervised variable grouping engine executed by the computer system, for each indicator variable, a vector length and a distance to a target vector, wherein each indicator variable initially forms a group;
automatically combining two groups of indicator variables that satisfy threshold conditions to create a combined group;
recalculating the combined group's vector length, distance to the target vector, and distance to vectors of other remaining groups;
iteratively combining and recalculating until there are no two groups that satisfy the threshold conditions or until a satisfactory number of groups is formed;
generating an altered data set of medical code groupings with reduced dimensionality; and
inputting the altered data set into a predictive model.

14. The non-transitory computer-readable medium of claim 13, wherein when two individual groups of indicator variables are combined, the individual groups are removed from the data set.

15. The non-transitory computer-readable medium of claim 13, wherein the threshold conditions defined by the user include thresholds for vector lengths, thresholds for distance of vectors to the target vector, and a threshold satisfactory number of groups.

16. The non-transitory computer-readable medium of claim 13, wherein the supervised variable grouping engine uses Euclidean distance or risk as a measure of distance from the indicator variable vectors to the target.

17. The non-transitory computer-readable medium of claim 13, wherein the data set contains records representing hospitalization claim records, and columns representing information regarding each claim.

18. The non-transitory computer-readable medium of claim 13, wherein the medical diagnosis codes are ICD-9 codes.
